(19) United States
(12) Patent Application Publication
(10) Pub. No.: US 2006/0169692 A1
(43) Pub. Date: Aug. 3, 2006

(54) Frame lid and container assembly with frame lid

(76) Inventor: Natalie Aronson, San Francisco, CA (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/050,511

(22) Filed: Feb. 3, 2005

(51) Int. Cl. B65D 51/26; B65D 51/00; G09F 3/00

(52) U.S. Cl. 220/212; 220/376; 220/377; 40/311

(57) ABSTRACT

A lid is provided. The lid includes a lid wall, the lid wall having a front side, a rear side, and an opening formed in the wall between the front side and the rear side. The lid also includes an attachment mechanism to attach a picture to the rear side the lid wall with at least a portion of the picture visible through the opening in the lid wall. Additionally, the lid includes a support to support the lid upright on a surface. Also provide is a container assembly including a container and such a lid.

### BACKGROUND

This patent is directed to a lid for use with a container and an assembly of a container and the lid, and in particular to a lid that may be used with a container and that may also be used as a frame and an assembly of a container and such a lid.

### SUMMARY OF THE INVENTION

In one aspect, a lid is provided. The lid includes a lid wall, the lid wall having a front side, a rear side, and an opening formed in the wall between the front side and the rear side. The lid also includes an attachment mechanism to attach a picture to the rear side of the lid wall with at least a portion of the picture visible through the opening in the lid wall. Additionally, the lid includes a support to support the lid upright on a surface.

In another aspect, a lid is provided. The lid includes a lid wall, the lid wall having a front side, a rear side, and an opening formed in the wall between the front side and the rear side. The lid wall defines a pocket adjacent the opening and at least in part one slot through which a picture may be disposed such that at least a portion of the picture is visible through the opening. The lid wall also includes a support attached to one of the lid wall and the pocket wall to support the lid upright on a surface.

In a further aspect, a container assembly is provided. The container assembly includes a container having a closed end and an open end and a lid disposed on the open end of the container. The lid includes a lid wall, the lid wall having a front side, a rear side, and an opening formed in the wall between the front side and the rear side. The lid also includes an attachment mechanism to attach a picture to the rear side of the lid wall with at least a portion of the picture visible through the opening in the lid wall. The lid also includes a support to support the lid upright on a surface.

Additional aspects of the disclosure are defined by the claims of this patent.

### BRIEF DESCRIPTION OF THE DRAWINGS

FIG. 1 is a front view of an embodiment of a lid according to the present disclosure;

FIG. 2 is a side view of the lid of FIG. 1;

FIG. 3 is a rear view of the lid of FIG. 1 including an embodiment of an attachment mechanism and an embodiment of a support attached to the rear of the lid;

FIG. 4 is a perspective view of the lid of FIG. 1 disposed on a container;

FIG. 4A is an exploded view of the lid and container shown in FIG. 4;

FIG. 5 is a front view of the lid of FIG. 1 supported on a surface;

FIG. 6 is a rear view of the lid of FIG. 1 including another embodiment of an attachment mechanism;

FIG. 7 is a rear view of the lid of FIG. 1 including another embodiment of a support attached to the rear of the lid;

FIG. 8 is a rear view of the lid of FIG. 1 including a further embodiment of a support attached to the rear of the lid; and

FIG. 9 is a perspective view of the lid of FIG. 8 supported on another surface.

### DETAILED DESCRIPTION OF VARIOUS EMBODIMENTS

Although the following text sets forth a detailed description of numerous different embodiments of the invention, it should be understood that the legal scope of the invention is defined by the words of the claims set forth at the end of this patent. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should also be understood that, unless a term is expressly defined in this patent using the sentence “As used herein, the term ‘______’ is hereby defined to mean . . .” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

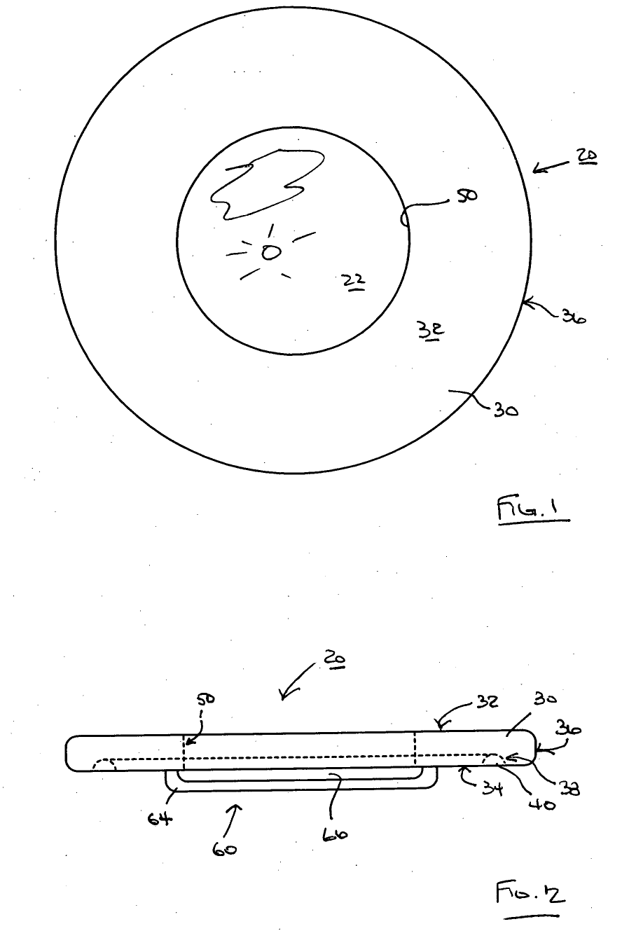

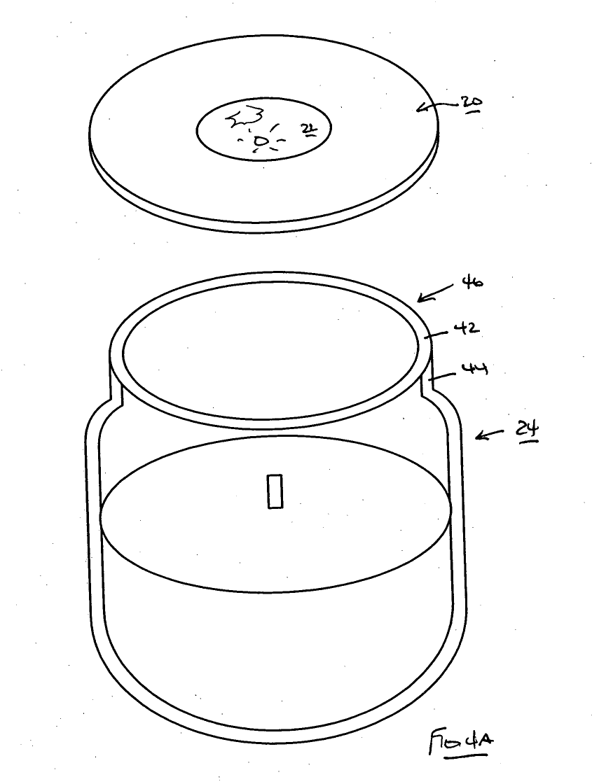

FIGS. 1-3 illustrate one possible embodiment of a lid 20 for use with a container. The lid 20 may include structures, as explained in greater detail below, to attach a picture 22 to the lid 20. As shown in FIG. 4, the lid 20 may be disposed on one end of a container 24. As shown in FIG. 5, the lid 20 may also be supported upright on a surface 26. Thus, the lid 20 may fulfill at least two purposes: the lid 20 may be used to close a container 24, limiting ingress and egress from the container, and the lid 20 may be used separate from the container 24 to display the picture 22, much like an ordinary frame would be used to display a picture.

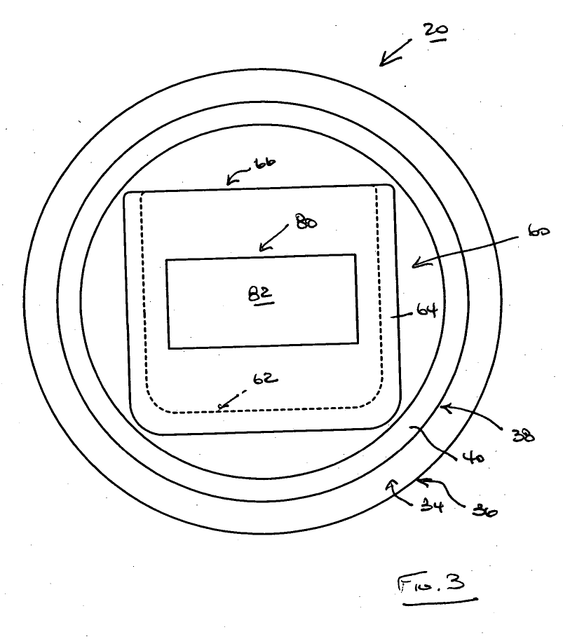

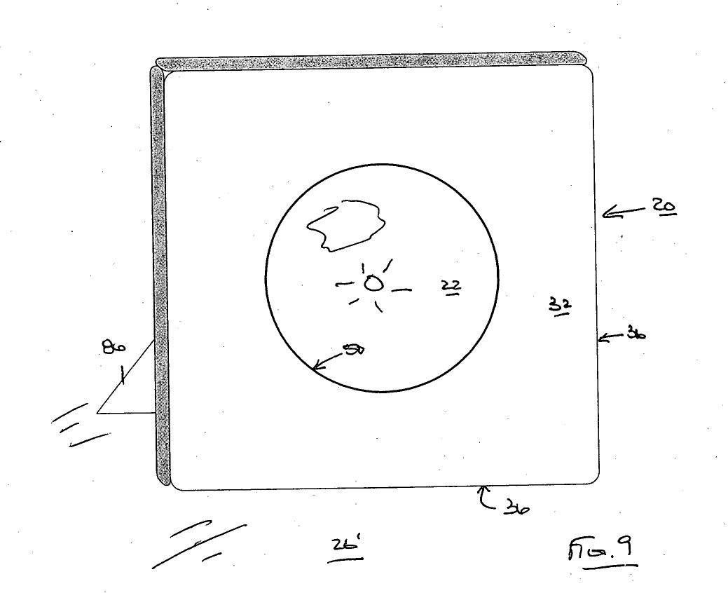

Returning to FIG. 1, it will be recognized that the lid 20 may include a lid wall 30. As seen in FIG. 2, the lid wall 30 may have a front side 32, a rear side 34, and an edge 36. As shown in FIG. 1, the lid wall 30 is circular in shape, such that the lid wall 30 has a single edge 36. However, the shape of the lid wall 30 is not limited to a circular shape, but may include any manner of shape, including oval, square, rectangular, etc. According to such alternative embodiments, the lid wall 30 may have multiple edges 36, such as may be seen in the embodiment shown in FIGS. 8 and 9.

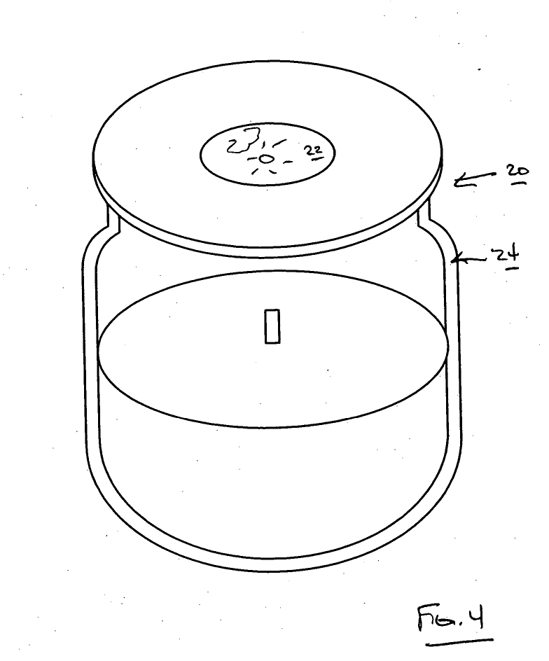

Additionally, the lid 20 may have a stepped region 38 on the rear side 34 of the lid wall 30. The stepped region 38 may be used to position and/or to secure the lid 20 to the container 24, which may be an apothecary-type jar with a candle disposed therein. As shown in FIG. 3, for example, the stepped region 38 may include a recess 40, which recess 40 may be of a shape and size to conform to a rim 42 defined by a wall 44 at an open end 46 of the container 24 (see FIG. 4A). According to the embodiment shown in FIGS. 1-3, the rim 42 of the container 24 may be disposed in the recess 40 in the rear side 34 of the lid wall 30 to position the lid 20 on the container 24.

It will be further recognized that the stepped region 38 may, in alternative embodiments, be shaped such that the stepped region 38 depends further into the open end 46 of the container 24. It will be further recognized that while the stepped region 38 of the lid wall 30 may be shaped to position and attach the lid 20 to the container 24, the lid wall 30, or at least the front side 32 of the lid wall 30, need not be the of a similar shape to the stepped region 38. For example, while the stepped region 38 is an annular shape and the lid wall 30 is a circular shape as shown, according to another embodiment, the stepped region 38 may be an annular or circular shape, but the remainder of the lid wall 30 may be oval, square, rectangular, etc. in shape, as shown, for example, in FIGS. 8 and 9.

The lid wall 30 may also have an opening 50 formed in the wall 30 from the front side 32 to the rear side 34. The picture 22 may be disposed behind the opening 50 so that the picture 22, or at least a portion of the picture 22, may be viewed through the opening 50. While the opening 50 is circular as shown, the opening 50 need not be constrained to a circular shape only, but may include other shapes, such as oval, square, rectangular, etc.

As shown, there is nothing disposed between the picture 22 and the opening 50. However, according to other embodiments, a layer of material may be disposed between the picture 22 and the opening 50, which material may limit the exposure of the picture 22 to environmental factors that might wear or damage the picture 22. For example, a layer of clear plastic or glass may be disposed between the picture 22 and the opening 50 to limit the exposure of the picture to environmental factors. Other materials may be used, which materials may or may not be transparent or translucent. Moreover, the layer of material may be disposed in the opening 50 rather than between the picture 22 and the opening 50, but to the same effect.

Referring to FIG. 3, the lid 20 may include an attachment mechanism 60, which attachment mechanism 60 may be disposed on the rear side 34 of the lid wall 30. The attachment mechanism 60 may be used to attach the picture 22 to the rear side 34 of the lid wall 30 with at least a portion of the picture 22 visible through the opening 50 in the lid wall 30. As shown, the attachment mechanism 60 may include a pocket 62 formed on the rear side 34 of the lid wall 30. The pocket 62 may be defined by a pocket wall 64, which may be integral with the lid wall 30, although that need not necessarily be the case in all embodiments. In certain embodiments, the pocket wall 64 may be formed separately from, but attached to or secured to, the lid wall 30.

The pocket 62 may be disposed adjacent the opening 50, such that a picture 22 disposed in the pocket 62, or at least a portion thereof, may be visible through the opening 50. At least one slot 66 may be formed in the rear side 34 of the lid wall 30, the at least one slot 66 being adjacent the pocket 62 and through which a picture 22 may be disposed such that the picture 22 may be disposed into the pocket 62. As shown, the pocket wall 64 and the lid wall 30 collectively define the slot 66, although according to other embodiments the slot 66 may be defined entirely by the pocket wall 64, for example.

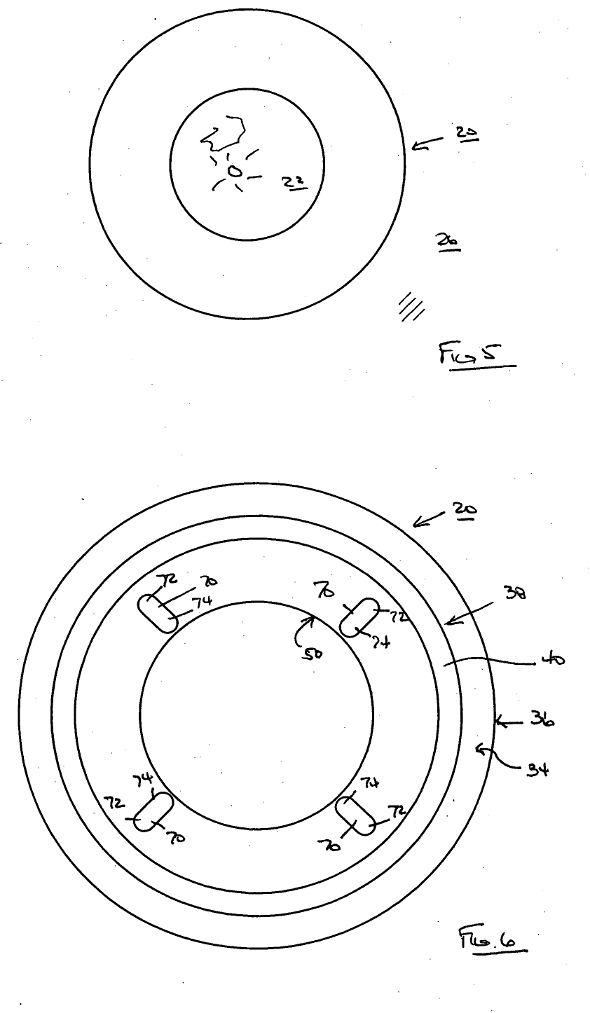

In the alternative, another embodiment of an attachment mechanism, designated 60′, is shown in FIG. 6. According to this embodiment, the attachment mechanism 60′ may include at least one clip 70 (as shown, four clips 70). Each clip 70 may have having a first end 72 attached to the lid wall 30 and a second end 74 movably biased towards the rear side 34 of the lid wall 30. That is, the second end 74 may be moved between a first position wherein the second end 74 abuts or is in close proximity to the rear side 34 of the lid wall 30 and a second position wherein the second end 74 is spaced from the rear side 34 of the lid wall 30, so that a picture 22 may be placed in or removed from the attachment mechanism 60′.

Returning again to FIG. 3, the lid 20 may also include a support 80. The support 80 may be used to position the lid 20 upright on the surface 26, such as shown in FIG. 5, or, according to alternative embodiments, as shown in FIG. 9. Using the lid 20 in this fashion, the lid 20 may function very similarly to a conventional frame.

According to the embodiment shown in FIG. 3, the support 80 may include a magnet 82 that may be attached or secured on the rear side 34 of the lid wall 30, and, in particular, to the pocket wall 64, as shown. The magnet 82 may be used to support the lid 20 upright on a metallic surface, such as the surface of an appliance, a refrigerator, for example.

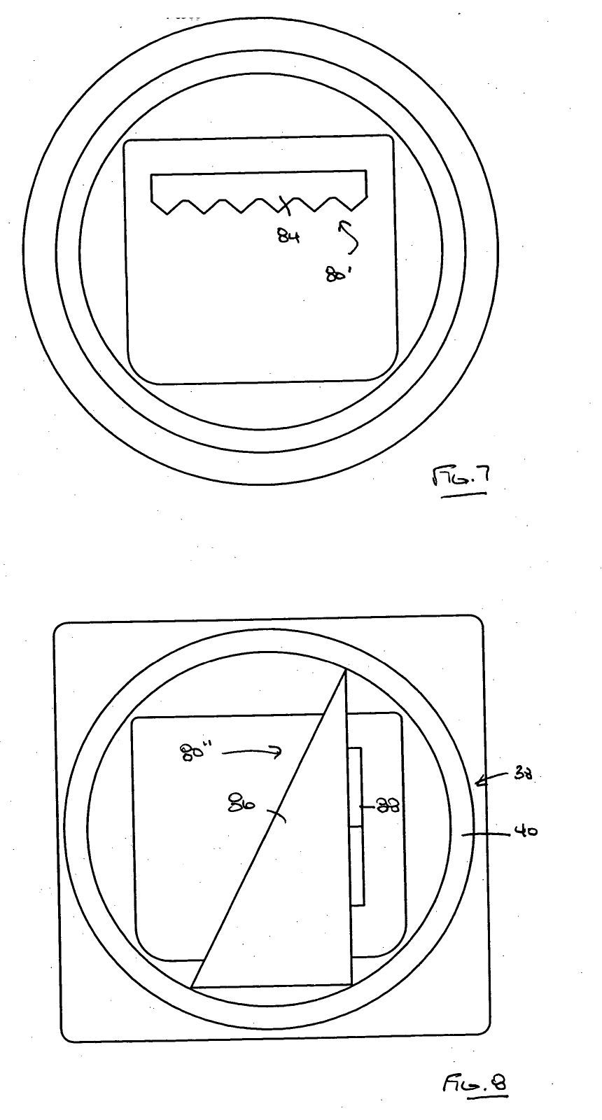

Other embodiments of the support, designated 80′ and 80″, are shown in FIGS. 7 and 8.

According to the embodiment of the support 80′ shown in FIG. 7, the support 80′ may include a hanger 84, such as is conventionally used to hang paintings and photographs on a wall, for example. The hanger 84, like the magnet 82, may be attached or secured on the rear side 34 of the lid wall 30, and, in particular, to the pocket wall 64. According to such an embodiment, the lid 20 may be supported upright as shown in FIG. 5 by inserting a nail or other fastener into the wall, and the coupling the lid 20 to the fastener using the hanger 84

According to the embodiment of the support 80″ shown in FIGS. 8 and 9, the support 80″ may include a moveable support or leg 86. The leg 86 may have a first position wherein the leg 86 abuts the rear side 34 of the lid wall 30 (as seen, for example, in FIG. 8) and a second position wherein the leg 86 is spaced from the rear side 34 of the lid wall 30. With the leg 86 in the second position, the lid 20 may be supported upright on a surface 26′ on one of the edges 36 of the lid wall 30 and on the leg 86 (as seen, for example, in FIG. 9). According to this embodiment, the leg 86 may be attached or secured on the rear side 34 of the lid wall 30, and, in particular, to the pocket wall 64, by a hinge 88.

What is claimed is:

1. A lid comprising:
a lid wall, the lid wall having a front side, a rear side, and an opening formed in the wall from the front side to the rear side;
attaching means for attaching a picture to the rear side of the lid wall with at least a portion of the picture visible through the opening in the lid wall; and
a support to support the lid upright on a surface.

2. The lid according to claim 1, wherein the attaching means comprises a pocket formed on the rear side of the lid wall, the pocket adjacent the opening, and at least one slot formed in the rear side of the lid wall, the slot adjacent the pocket and through which a picture may be disposed such that at least a portion of the picture is visible through the opening.

3. The lid according to claim 1, wherein the attaching means comprises a pocket wall attached to the rear side of the lid wall and spaced from the opening to form a pocket adjacent the opening, the pocket wall having at least one slot through which a picture may be disposed such that at least a portion of the picture is visible through the opening.

4. The lid according to claim 1, wherein the attaching means comprises a clip having a support end attached to the lid wall and a second end movably biased against the rear side of the lid wall.

5. The lid according to claim 1, wherein the support comprises a magnet.

6. The lid according to claim 1, wherein the support comprises a hanger.

7. The lid according to claim 1, wherein the support comprises a moveable support, the support having a first position wherein the support abuts the rear side of the lid wall and a second position wherein the support is spaced from the rear side of the lid wall, the lid being supported upright on a surface on an edge of the lid wall and the moveable support.

8. A lid comprising:
a lid wall, the lid wall having a front side, a rear side, and an opening formed in the wall between the front side and the rear side,
the lid wall defining a pocket adjacent the opening and at least one slot through which a picture may be disposed such that at least a portion of the picture is visible through the opening; and
a support attached to one of the lid wall and the pocket wall to support the lid upright on a surface.

9. The lid according to claim 8, wherein the support comprises a magnet.

10. The lid according to claim 8, wherein the supporting means comprises a hanger.

11. The lid according to claim 8, wherein the support comprises a moveable support, the support having a first position wherein the support abuts the rear side of the lid wall and a second position wherein the support is spaced from the rear side of the lid wall, the lid being supported on a surface on an edge of the lid wall and the moveable support.

12. A container assembly comprising:
a container having a closed end and an open end;
a lid disposed on the open end of the container,
the lid including a lid wall, the lid wall having a front side, a rear side, and an opening formed in the wall between the front side and the rear side, attaching means for attaching a picture to the rear side of the lid wall with at least a portion of the picture visible through the opening in the lid wall, and a support to support the lid upright on a surface.

13. The container assembly according to claim 12, wherein the container is an apothecary-type jar.

14. The container assembly according to claim 13, further comprising a candle disposed in the container.
